(19) United States
(12) Patent Application Publication
(10) Pub. No.: US 2015/0352641 A1
(43) Pub. Date: Dec. 10, 2015

(54) CLAMPING SYSTEM FOR A WORKPIECE ON A MEASURING MACHINE

(71) Applicant: Klingelnberg AG, Zurich (CH)

(72) Inventor: Georg MIES, Wipperfuerth (DE)

(73) Assignee: KLINGELNBERG AG, Zurich (CH)

(21) Appl. No.: 14/731,937

(22) Filed: Jun. 5, 2015

(30) Foreign Application Priority Data
Jun. 6, 2014 (DE) 20 2014 004 713.8

(51) Int. Cl. B23B 31/163; B23B 31/28

(52) U.S. Cl. CPC B23B 31/16004; B23B 31/28; B23B 2270/022

(57) ABSTRACT

The invention includes a clamping system for a workpiece on a measuring machine, with a multiple-jaw clamping chuck. A rotary drive rotates the multiple-jaw clamping chuck. The rotary drive includes a stator and a rotor. The multiple-jaw clamping chuck has a chuck body wherein the clamping jaws are radially movable for clamping a workpiece or loosening it from the clamping chuck, a flat spiral mounted rotating relative to the chuck body in positive engagement with the clamping jaws, and an outer rim rotating with respect to the stator. The flat spiral is firmly joined to the rotor of the rotary drive, but can turn relative to the chuck body in order to move the clamping jaws radially inward or outward. Using a coupling, a part of the clamping system can be secured so that the rotary drive takes on the function of adjusting the clamping jaws.

### BACKGROUND OF THE INVENTION

1. Field of the Invention

The invention is directed to a clamping system for a workpiece on a measuring machine, with a multiple-jaw clamping chuck and with a rotary drive provided for the rotation of the multiple-jaw clamping chuck, wherein the rotary drive comprises a stator and a rotor and wherein the multiple-jaw clamping chuck has a chuck body, in which the clamping jaws are radially movable for clamping a workpiece in the clamping chuck or loosening it from the clamping chuck, a flat spiral mounted so that it can rotate relative to the chuck body, being in positive engagement with the clamping jaws, and an outer rim able to rotate with respect to the stator.

2. Discussion of the Related Art

A measuring machine, on which a clamping system of the aforementioned kind is used, can be found for example in the company brochure “KLINGELNBERG P26/P40 Precision Measuring Centers” with the publication information “DE 05/2013”. On page 4 this describes a precision measuring center in which the measuring machine has a heavy-duty precision rotary table. This is designed as a measuring axis (C axis) and concentrically holds the workpieces being checked. In combination with three linear measuring axes: tangential (X axis), radial (Y axis) and vertical (Z axis), the precision measuring centers probe functional surfaces on gear teeth and general drive components in generator mode and verify them with utmost accuracy of measurement and reproduction.

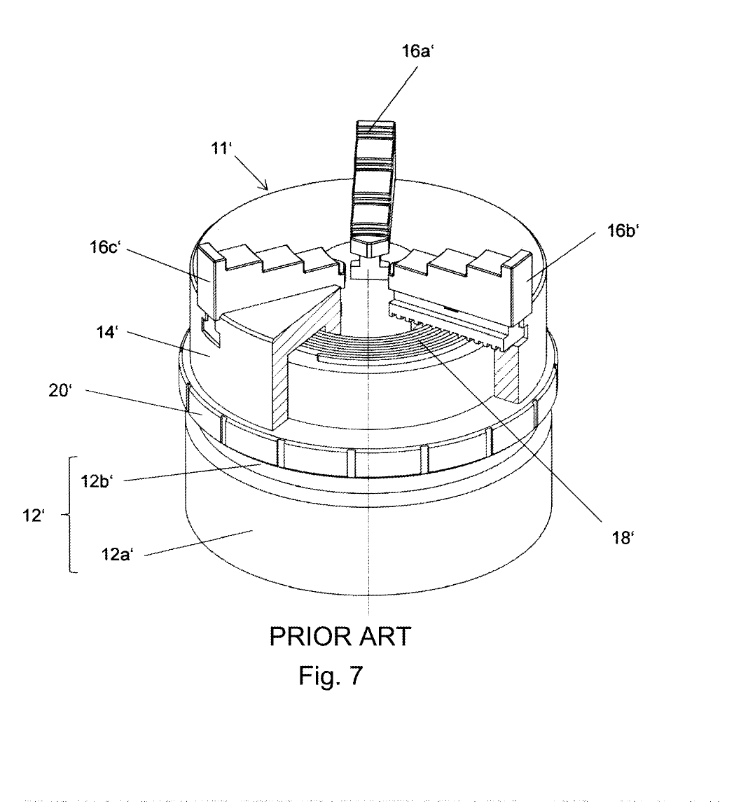

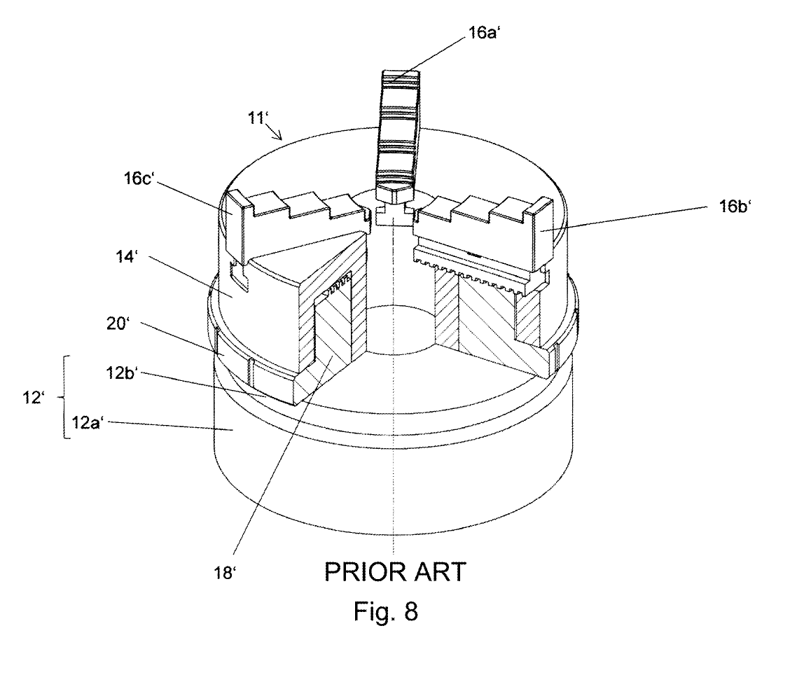

In the present P series of the applicant, to which the precision measuring centers P26 and P40 belong according to the aforementioned company brochure, there is the possibility of holding the workpieces by clamping between centers (shown in the company brochure on page 4), holding it in the clamping chuck (shown in the company brochure on page 12, left figure in the next to last row of figures) and direct placement of the workpiece on the rotary table, possibly with an adapted base (boom or faceplate). Direct placement is used in practice only for large workpieces. In a measuring machine as is partly visible in the aforementioned figure on page 12 of the company brochure there is no backstop, so that the clamping between centers does not occur in this machine. When it involves workpieces of low weight, a measuring of workpieces only set down in place is not recommended. Therefore, in the machine per page 12 of the company brochure the workpieces being measured are held in a clamping system with a multiple-jaw clamping chuck. Such a multiple-jaw clamping chuck is shown in the enclosed drawings in FIGS. 7 and 8, to which reference shall now be made.

The multiple-jaw clamping chuck designated overall as 11′ is provided with an electrical rotary drive 12′ for rotation of the multiple-jaw clamping chuck. The rotary drive 12′ comprises a stator 12a′ and a rotor 12b′. Moreover, the multiple-jaw clamping chuck 11′ has a chuck body 14′. The chuck body 14′ is firmly joined to the rotor 12b′ internally. Jaws 16a′, 16b′ and 16c′ in the chuck body 14′ are moved radially in order to clamp a workpiece (not shown) in the multiple-jaw clamping chuck 10′ or to loosen it from the multiple-jaw clamping chuck 11′. A flat spiral 18′ is mounted with ability to rotate relative to the chuck body 14′ and in positive engagement with the jaws 16a′, 16b′ and 16c′. While the chuck body 14′ is held by one hand, the flat spiral 18′ is rotated to clamp or release a workpiece (not shown) by the other hand via an external rim 20′. The external rim 20′ is firmly arranged on the flat spiral 18′, for example, it is integrally formed therewith. By turning the flat spiral 18′ relative to the chuck body 14′, the clamping jaws 16a′, 16b′ and 16c′ are moved radially. The rotary drive 12′ serves to rotate the complete multiple-jaw clamping chuck 10′ including the clamped workpiece. The performance of the clamping process in this known clamping system is not comfortable, because the activating of the clamping system must be done with both hands. Accordingly, the operator has no hands free to hold the workpiece while clamping or loosening it. Furthermore, the known clamping system only handles a small range of clamping situations. Moreover, the operator has little control over the force exerted on the workpiece being clamped. What is more, the clamping jaws require many steps when the clamping range is large and the clamping diameter has to be set quickly and manually.

The object of the invention is to ensure an easier handling of the clamping system and handle a broader range of clamping situations for a clamping system of the aforementioned kind.

### SUMMARY OF THE INVENTION

This object is achieved according to the invention, starting from a clamping system of the kind mentioned above, in that the flat spiral is firmly joined to the rotor of the rotary drive, but can turn relative to the chuck body in order to move the clamping jaws radially inward or outward, and with the help of a coupling a part of the clamping system can be secured during a clamping or releasing process so that the rotary drive takes on the function of adjusting the clamping jaws.

As compared to a manually operated clamping system the clamping system of the invention, which is motorized, i.e., operated by the electrical rotary drive of the multiple-jaw clamping chuck, offers the following advantages:
One or a few steps are needed in the clamping jaws when the clamping range is large enough, because the clamping diameter can be quickly set in motorized manner.
The setting of the clamping diameters can be done automatically by selecting the drawing number.
Comfortable single-hand operation, clamping by the press of a button.
The workpiece clamping force can be adjusted.
Easy automation is possible.

These advantages are achieved because the invention involves a motorized clamping system, in which the electric rotary drive present any way in the C axis is used for the activation. The clamping function of the clamping system according to the invention is realized on the basis of standard technologies of a multiple-jaw clamping chuck, especially a three-jaw clamping chuck. With the help of a coupling, a part of the clamping system is secured during a clamping or loosening process, so that the drive unit takes on the function of the adjustment of the clamping jaws. The torque of the C axis rotary drive can be regulated with high precision. Thanks to this torque regulation, a regulating of the force of the workpiece clamping is possible. The direct coupling of the C axis rotary drive to the C axis remains intact in the clamping system of the invention. As a result, the C axis regulation is not influenced by the clamping system.

Thanks to the use according to the invention of the electric rotary drive which is present any way and standard technology for the clamping system, an economically attractive solution is also achieved.

In one embodiment of the clamping system according to the invention, the fixable part of the clamping system comprises the outer rim. The outer rim is joined to the chuck body in torque-proof manner. The chuck body can be coupled in frictional or positive manner by the other rim across the coupling to the stator of the rotary drive. Both coupling options allow the rotary drive to use the C axis in easy manner to fix a part of the clamping system with the help of the coupling during a clamping or loosening process, so that the rotary drive of the C axis takes on the function of the clamping jaw adjustment. This does not interrupt the direct coupling of the C axis/rotary drive to the C axis by the coupling, so that the C axis control as already mentioned is not affected by the clamping system according to the invention.

In a further embodiment of the clamping system according to the invention, the outer rim is configured such that the chuck body can be coupled by friction to the stator of the rotary drive in the manner of a drum or disk brake. In this and in another embodiment of the clamping system according to the invention, in which the outer rim has a toothing and the coupling has a coupling lever with a toothing linked to the stator of the rotary drive, which can be brought into engagement with the toothing of the outer rim, the coupling is activated only by the press of a button. The clamping or loosening process then occurs with the aid of the electrical rotary drive of the multiple-jaw chuck. The chuck body is in fact joined to the outer rim in torque-proof manner and mechanically coupled via the coupling toothing and the coupling lever to the stator, so that the chuck body does not turn along while the rotor turns the flat spiral. When the coupling is not activated and the workpiece is clamped, the rotary drive serves as usual to rotate the complete multiple-jaw chuck, including the workpiece.

In yet a further embodiment of the clamping system according to the invention, the chuck body is designed as a brake drum and the coupling has a clamping ring with brake shoes linked to the stator of the rotary drive, by which the chuck body can be coupled by friction to the stator of the rotary drive. This is an advantageous embodiment of a clamping system in which the chuck body can be coupled by friction with the stator of the rotary drive in the manner of a drum brake.

In yet a further embodiment of the clamping system according to the invention, the outer rim is configured as a brake disk and the coupling has, as actuator, a caliper firmly connected to the stator of the rotary drive, which encloses the brake disk like pliers and carries brake linings, so that the chuck body can be coupled frictionally to the stator by pressing the brake linings against the brake disk. This is an advantageous embodiment of a clamping system in which the chuck body can be coupled frictionally to the stator of the rotary drive in the manner of a disk brake.

In yet a further embodiment of the clamping system according to the invention, the chuck body can be coupled frictionally or by form fitting to the stator of the rotary drive with the help of a manually, electrically, pneumatically or hydraulically operated actuator. This enables, as already mentioned, the clamping by press of a button, and thus a comfortable single-hand operation of the clamping system as well as easy automation.

### BRIEF DESCRIPTION OF THE INVENTION

Sample embodiments of the invention shall be described more closely in the following, making reference to the drawings. These show

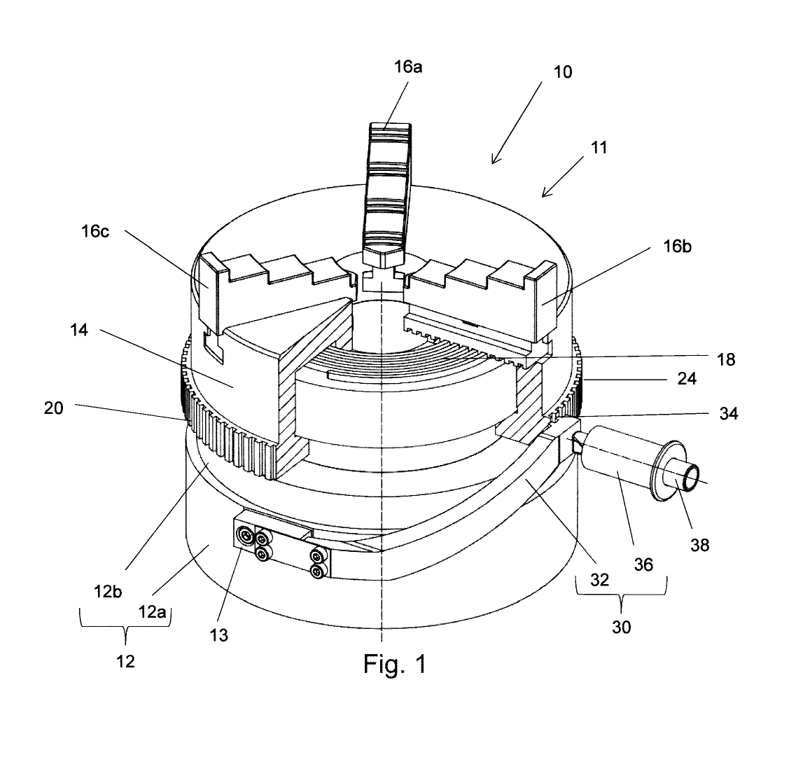

FIG. 1 a first embodiment of a motorized clamping system according to the invention in a partial sectional view,

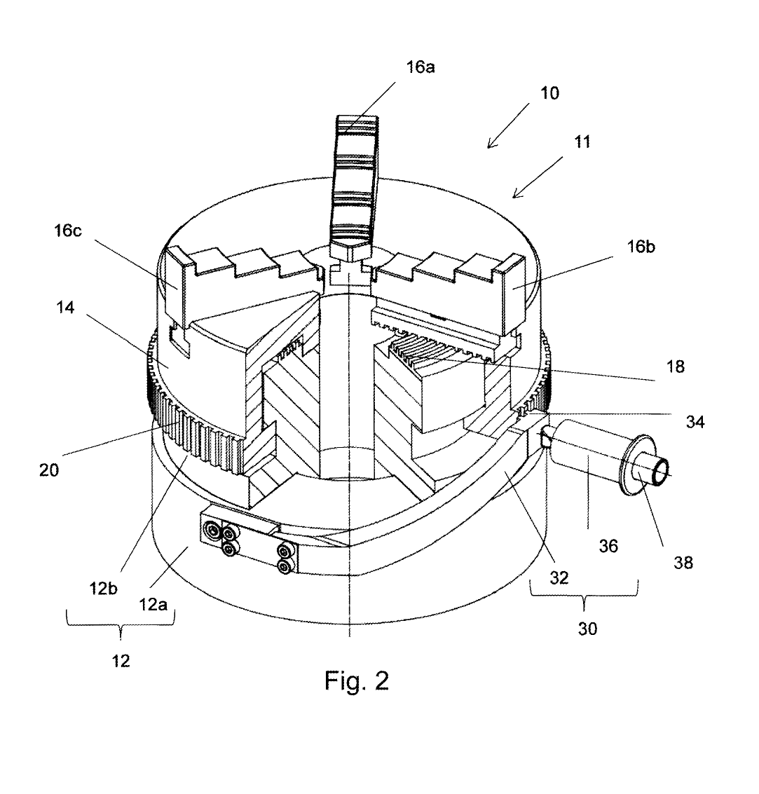

FIG. 2 the clamping system of FIG. 1, but in which besides a chuck body provided with an outer rim there is also shown a flat spiral in a partial sectional view,

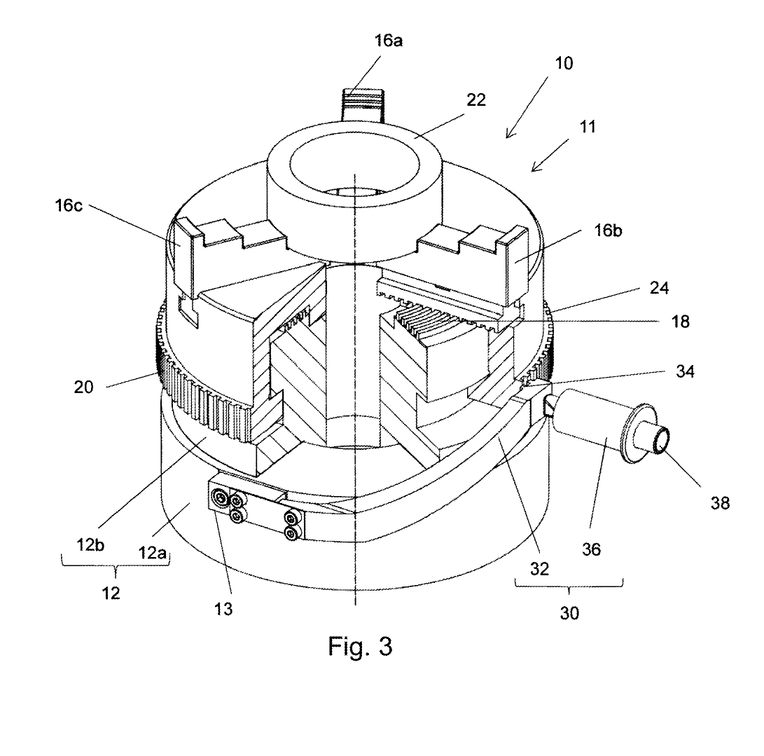

FIG. 3 the clamping system of FIG. 2, but with a clamped workpiece,

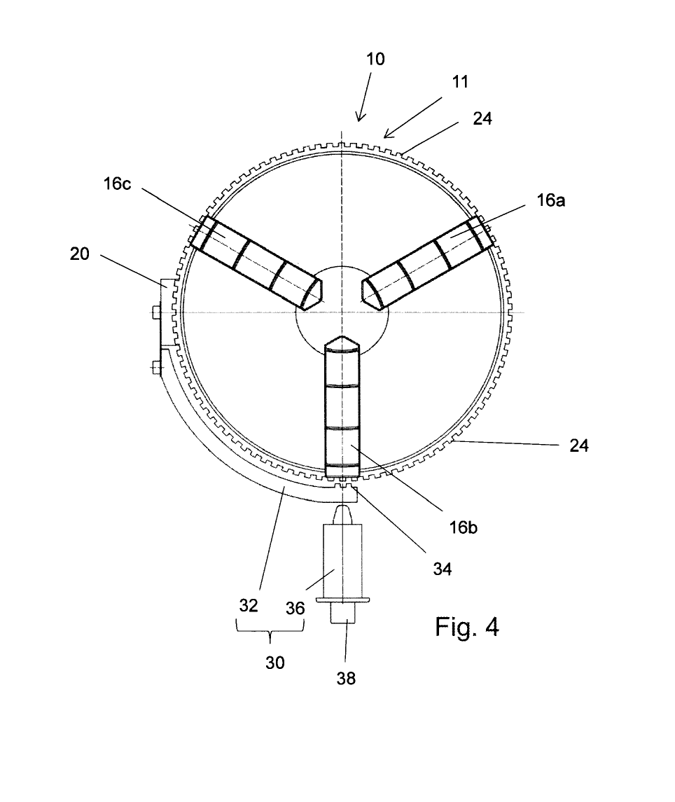

FIG. 4 the clamping system of FIG. 1 in a view from above,

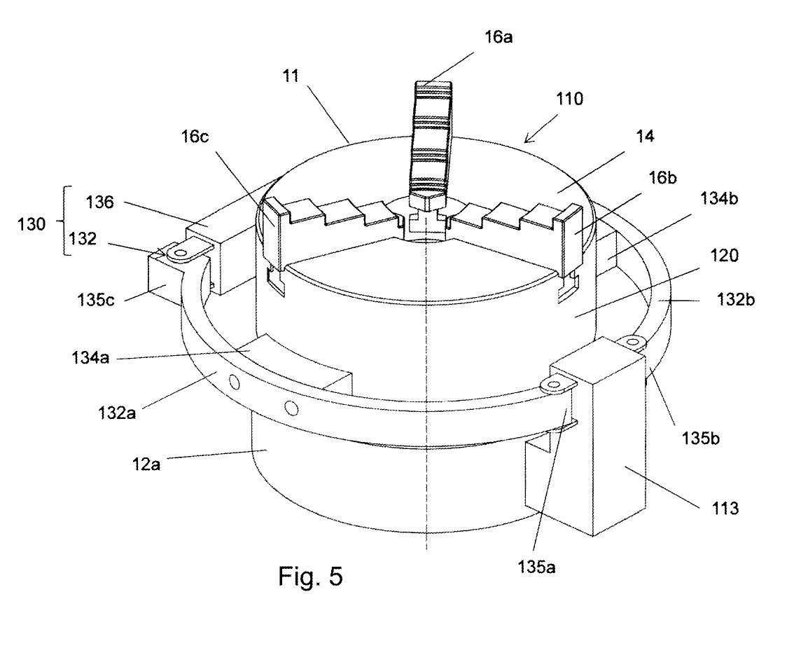

FIG. 5 a second embodiment of the motorized clamping system according to the invention,

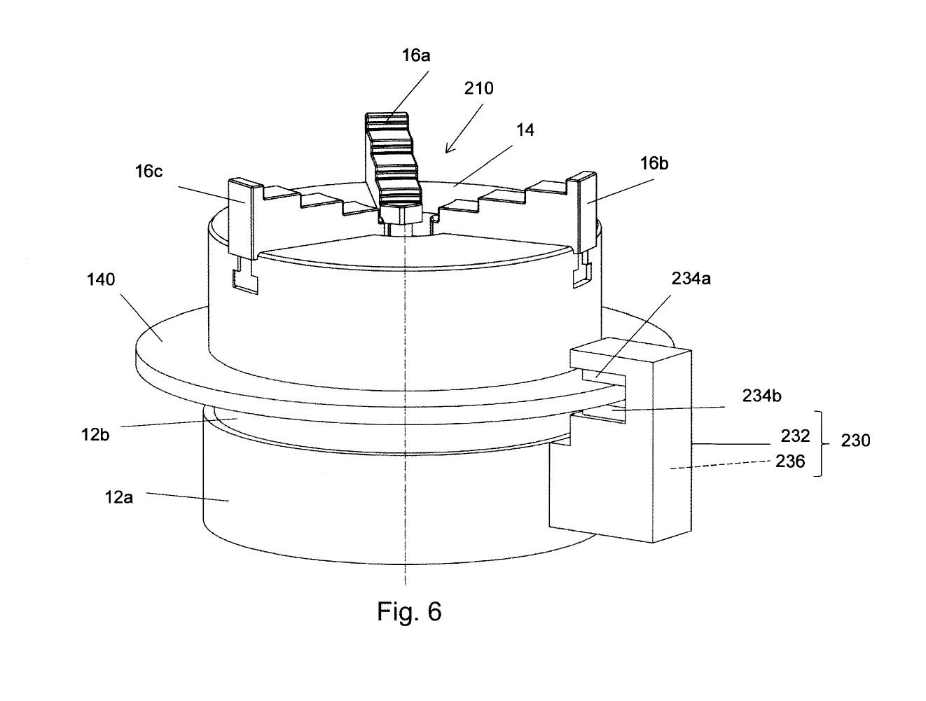

FIG. 6 a third embodiment of the motorized clamping system according to the invention,

FIG. 7 a traditional three-jaw clamping chuck in a partial sectional view, and

FIG. 8 the traditional three-jaw clamping chuck of FIG. 7 in another partial sectional view.

### DETAILED DESCRIPTION OF THE INVENTION

A first embodiment of a motorized clamping system according to the invention is shown in FIG. 1 in a partial sectional view and in FIG. 4 in a view from above and designated generally as 10. A multiple-jaw clamping chuck 11, being a three-jaw chuck in the case of the embodiment shown in FIGS. 1 and 4, is provided with an electrical rotary drive 12 for turning the multiple-jaw clamping chuck 11. The rotary drive 12 comprises a stator 12a and a rotor 12b. Furthermore, the multiple-jaw clamping chuck 11 has a chuck body 14. The chuck body 14 is not connected firmly to the rotor 12b on the inside as is the chuck body 14′ in the traditional multiple-jaw clamping chuck 11′ of FIGS. 7 and 8, but rather can turn relative to the rotor 12b. Clamping jaws 16a, 16b and 16c are radially movable in the chuck body 14 so as to clamp a workpiece 22 (shown in FIG. 3) in the multiple-jaw clamping chuck 11 or loosen it from the multiple-jaw clamping chuck 11.

A flat spiral 18, on which the chuck body 14 is rotationally mounted, if connected firmly on the inside to the rotor 12b or forms a single piece with the rotor 12b as in the representation of FIG. 3, yet continues to be able to turn relative to the chuck body. The flat spiral 18 engages with the clamping jaws 16a, 16b and 16c by positive engagement or positive coupling. Thanks to a rotation of the flat spiral 18 relative to the chuck body 14 brought about with the help of the electrical rotary drive 12, the clamping jaws 16a, 16b and 16c are moved radially. However, the turning of the flat spiral 18 is not done manually, as in the traditional multiple-jaw clamping chuck 11′, but is motorized with the help of the electrical rotary drive 12, which is the rotary drive of a measuring machine (not shown), in whose C axis the multiple-jaw clamping chuck 11 is arranged with the workpiece 22 being measured. The measurement on the workpiece 22 and the measurement layout correspond to those in a measuring machine according to the aforementioned company brochure “KLINGELNBERG P26/P40 precision measuring centers”. A rotary table of the measuring machine, which is designed as the measuring or C axis, holds the workpiece being checked in concentric fashion.

In the embodiment shown in FIGS. 1 and 4, an outer rim 20 is integrally formed on the chuck body 14, i.e., it forms a single piece with it. On its outer circumference the outer rim 20 does not have a knurling or the like to facilitate the manual activation of the outer rim 20, but instead a toothing 24, which is part of a coupling designated overall as 30. With the help of the coupling 30, a part of the clamping system 10 can be fixed during a clamping or loosening process, so that the electrical rotary drive of the measuring machine, being represented here by the stator 12a and the rotor 12b, can take on the function of the clamping jaw adjustment. The fixable part of the clamping system 10 is the chuck body 14 with the outer rim 20. The coupling 30 comprises a coupling lever 32 with a toothing 34, spring-hinged to the stator 12a of the electrical rotary drive 12 on a support block 13, which can engage in positive coupling manner with the toothing 24 of the outer rim 20. The activating of the coupling lever 32 is done by a manually, electrically or pneumatically controlled actuator 36. Thus, by means of the coupling 30, the outer rim 20 and thus the chuck body 14 can be fixed on the stator 12a, so that the electrical rotary drive 12 takes on the function of the clamping jaw adjustment by placing the flat spiral 18 in rotation relative to the chuck body 14. In this way, the clamping jaws 16a, 16b and 16c are moved radially. Since the chuck body 14 is mechanically linked to the stator 12a across the coupling toothings 24 and 34 and the coupling lever 32, the chuck body 14 does not rotate along when the rotor 12b turns the flat spiral 18. When the coupling 30 is not activated and a workpiece 22 is clamped in the clamping jaws 16a, 16b and 16c, the electrical rotary drive 12 serves to turn the multiple-jaw clamping chuck 11 along with the workpiece 22 in traditional fashion. The force acting upon the clamped workpiece 22 via the clamping jaws 16a, 16b and 16c is adjusted by controlling the torque of the electrical rotary drive 12. The operation of the clamping system 10 can be done with one hand by pressing a button 38, which controls the actuator 36. The operator's other hand is free to hold the workpiece 22 while it is being clamped or released.

In the representation in FIG. 2 of the clamping system 10 of FIG. 1, besides the chuck body 14 provided with the outer rim 20 there is also shown the flat spiral 18 in a partial sectional view. The firm connection of the flat spiral 18 to the rotor 12b can be produced by a positive or material-bonded connection (the latter is shown in FIG. 2).

FIG. 5 shows a second embodiment of a motorized clamping system according to the invention, being generally designated as 110. It differs from the clamping system 10 in that a coupling 130 couples the chuck body 14 to the stator 12a of the rotary drive 12 not by positive coupling through an outer rim, but instead couples the chuck body 14 frictionally to the stator 12a of the rotary drive 12. For this purpose, the chuck body 14 with the outer rim is fashioned on the outside as a brake drum 120.

Furthermore, the coupling lever 32 present in the first embodiment is replaced by a clamping ring, designated overall as 132. The clamping ring has two clamping ring segments 132a and 132b. The clamping ring segments 132a, 132b each carry a brake shoe 134a and 134b. The clamping ring segments 132a, 132b are each linked at one end 135a and 135b to a support block 113, which is firmly mounted on the stator 12a like the support block 13 of the clamping system 10, for example by means of a screw fastening. The latter is not shown in FIG. 5, but it is shown with the support block 13 of the clamping system 10 (for example, in FIG. 1). The clamping ring segment 132a is linked at another end 135c to an actuator 136. The actuator 136 can be a piston and cylinder unit, which is pneumatically, hydraulically or electromagnetically operated, like the actuator 36. In FIG. 5, only one end of the actuator 136 can be seen. This end of the actuator 136 is linked to the end 135c of the clamping ring segment 132a. When the actuator 136 is a piston and cylinder unit, the actuator 136 is linked at its other end, which cannot be seen in FIG. 5, by an end of a piston rod sticking out from the actuator 136 to the other end of the clamping ring segment 132b, also not seen in FIG. 5. Thanks to an operating button, which also cannot be seen in FIG. 5, the actuator 136 of the clamping system 110 can be controlled like the actuator 36 of the clamping system 10. When the actuator 136 is activated for clamping by the operating button, the piston rod is retracted into the actuator 136 and thereby clamps the brake shoes 134a, 134b firmly against the brake drum 120 with the help of the clamping ring 132, so as to couple the chuck body 14 frictionally to the stator 12a. Thus, the fixable part of the clamping system 110 here is the chuck body 14, which is configured as the brake drum 120.

FIG. 6 shows a third embodiment of a motorized clamping system according to the invention, designated generally as 210. It differs from the clamping system 110 of FIG. 5 in that the chuck body 14 is configured not as a brake drum 120, but instead carries a brake disk 140. In other words, the outer rim 20 of the clamping system 10 in the case of the clamping system 110 is fashioned as a brake disk 140. Moreover, the coupling 230 has as its actuator a caliper 213 firmly connected to the stator 12a of the rotary drive 12. The caliper 213 encloses the brake disk 140 like pliers and carries brake linings 234a, 234b, so that the chuck body 14 can be frictionally coupled to the stator 12a by pressing the brake linings 234a, 234b against the brake disk 140. Thus, the fixable part of the clamping system 210 is the chuck body 14 with the brake disk 140 integrally formed therewith or firmly mounted on it.

In the clamping system 110 of FIG. 5 and the clamping system 210 of FIG. 6, the chuck body 14 can be coupled to the stator 12a of the rotary drive 12 by means of a manually, electrically, pneumatically or hydraulically operated actuator 136 or 236, but by frictional coupling and not by positive coupling The actuator 236 is only suggested in the representation of FIG. 6. This involves the typical activating mechanism for the brake linings, which is arranged inside the caliper 213.

### LIST OF REFERENCE NUMBERS

10, Clamping system
11, 11′ Multiple-jaw clamping chuck
12, 12′ Rotary drive
12a, 12a′ Stator
12b, 12b′ Rotor
13 Support block
14, 14′ Chuck body
16a, 16a′ Clamping jaw
16b, 16b′ Clamping jaw
16c, 16c′ Clamping jaw
18, 18′ Flat spiral
20, 20′ Outer rim
22 Workpiece
24 Toothing
30 Coupling
32 Coupling lever
34 Toothing
36 Actuator
38 Button
110 Clamping system
113 Support block
120 Brake drum
130 Coupling
132 Clamping ring
132a, 132b Clamping ring segment
134a, 134b Brake shoe
135a, 135b End
136 Actuator
140 Brake disk
142 Brake caliper
210 Clamping system
230 Coupling
232 Caliper
234a, 234b Brake lining
236 Actuator

1. A clamping system for a workpiece on a measuring machine, the clamping system comprising:
a multiple-jaw clamping chuck comprising a chuck body and a plurality of clamping jaws, the plurality of clamping jaws are radially movable for clamping the workpiece in the clamping chuck or loosening it from the clamping chuck;
a rotary drive rotating the clamping chuck, the rotary drive comprises a stator and a rotor;
a flat spiral rotating relative to the chuck body to move the plurality of clamping jaws radially inward or outward, the flat spiral being in positive engagement with the plurality of clamping jaws, the flat spiral is firmly joined to the rotor;
an outer rim rotating with respect to the stator; and
a coupling securing a part of the clamping system during a clamping or releasing process so that the rotary drive adjusts the plurality of clamping jaws.

2. The clamping system according to claim 1,
wherein a fixable part of the clamping system comprises the outer rim,
wherein the outer rim is joined to the chuck body in torque-proof manner, and
the chuck body is coupled in frictional or positive manner through another rim across the coupling to the stator of the rotary drive.

3. The clamping system according to claim 2, wherein the outer rim is configured such that the chuck body can be coupled by friction to the stator of the rotary drive in the manner of a drum or disk brake.

4. The clamping system according to claim 2, wherein the outer rim has a toothing and that the coupling has a coupling lever with a toothing linked to the stator of the rotary drive, which can be brought into engagement with the toothing of the outer rim.

5. The clamping system according to claim 2, wherein the chuck body is designed as a brake drum and the coupling has a clamping ring with brake shoes linked to the stator of the rotary drive, by which the chuck body can be coupled by friction to the stator of the rotary drive.

6. The clamping system according to claim 2, wherein the outer rim is configured as a brake disk and the coupling has, as an actuator, a caliper firmly connected to the stator of the rotary drive, which encloses the brake disk like pliers and carries brake linings, so that the chuck body can be coupled frictionally to the stator by pressing the brake linings against the brake disk.

7. The clamping system according to claim 1, wherein the chuck body is coupled frictionally or by positive engagement to the stator of the rotary drive with a manually, electrically, pneumatically or hydraulically operated actuator.
